(19) United States
(12) Patent Application Publication
(10) Pub. No.: US 2011/0126683 A1
(43) Pub. Date: Jun. 2, 2011

(54) Rotary Sheet Metal Cutter

(76) Inventor: Raymond Dueck, St. Adolphe (CA)

(21) Appl. No.: 12/627,607

(22) Filed: Nov. 30, 2009

(51) Int. Cl. B23D 19/00

(52) U.S. Cl. 83/500

(57) ABSTRACT

A rotary sheet metal cutter for cutting sheet metal in various curvatures. The rotary cutter generally includes a base, a first cutting assembly supported by the base and including a first drive assembly and a first circular blade, a second cutting assembly supported by the base and including a second drive assembly and a second circular blade cooperating with the first circular blade. The first circular blade is driven in a first rotational direction and the second circular blade is driven in a second rotational direction opposite the first rotational direction. The first circular blade and the second circular blade each include an overlapping portion along a feed path for cutting a piece of sheet metal engaging the overlapping portions of the first circular blade and the second circular blade. Another circular blade aligned with the first circular blade may also be used.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a cutting device and more specifically it relates to a rotary sheet metal cutter for efficiently cutting sheet metal in various curvatures.

2. Description of the Related Art

Any discussion of the related art throughout the specification should in no way be considered as an admission that such related art is widely known or forms part of common general knowledge in the field.

Cutting curvatures and straight lines in heavy gauge sheet metal can often be a time consuming and difficult procedure. Generally different types of metal shears are used to cut repetitive sections of sheet metal, such as when cutting cone formable sheets for grain or storage bins. The shears however are not very effective at cutting curvatures, which results in the curvatures being cut by hand or other methods. Cutting the heavy gauge sheet metal by hand can often times be very labor intensive, relatively slow, and requires a large number of laborers for volume production. Because of the inherent problems with the related art, there is a need for a new and improved rotary sheet metal cutter for efficiently cutting sheet metal in various curvatures.

### BRIEF SUMMARY OF THE INVENTION

A system for efficiently cutting sheet metal in various curvatures. The invention generally relates to a cutting device which includes a base, a first cutting assembly supported by the base and including a first drive assembly and a first circular blade, a second cutting assembly supported by the base and including a second drive assembly and a second circular blade cooperating with the first circular blade. The first circular blade is driven in a first rotational direction and the second circular blade is driven in a second rotational direction opposite the first rotational direction. The first circular blade and the second circular blade each include an overlapping portion along a feed path for cutting a piece of sheet metal engaging the overlapping portions of the first circular blade and the second circular blade. Another circular blade aligned with the first circular blade may also be used.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention in use cutting a curve in a piece of sheet metal.

FIG. 3 is a side view of the present invention illustrating the second transfer assembly and the blades cutting a piece of sheet metal.

FIG. 4 is another side view of the present invention illustrating the second transfer assembly and the blades cutting a piece of sheet metal.

FIG. 5 is a front view of the present invention.

FIG. 6 is a front view of an alternate embodiment of the present invention having three circular blades.

### DETAILED DESCRIPTION OF THE INVENTION

### A. Overview

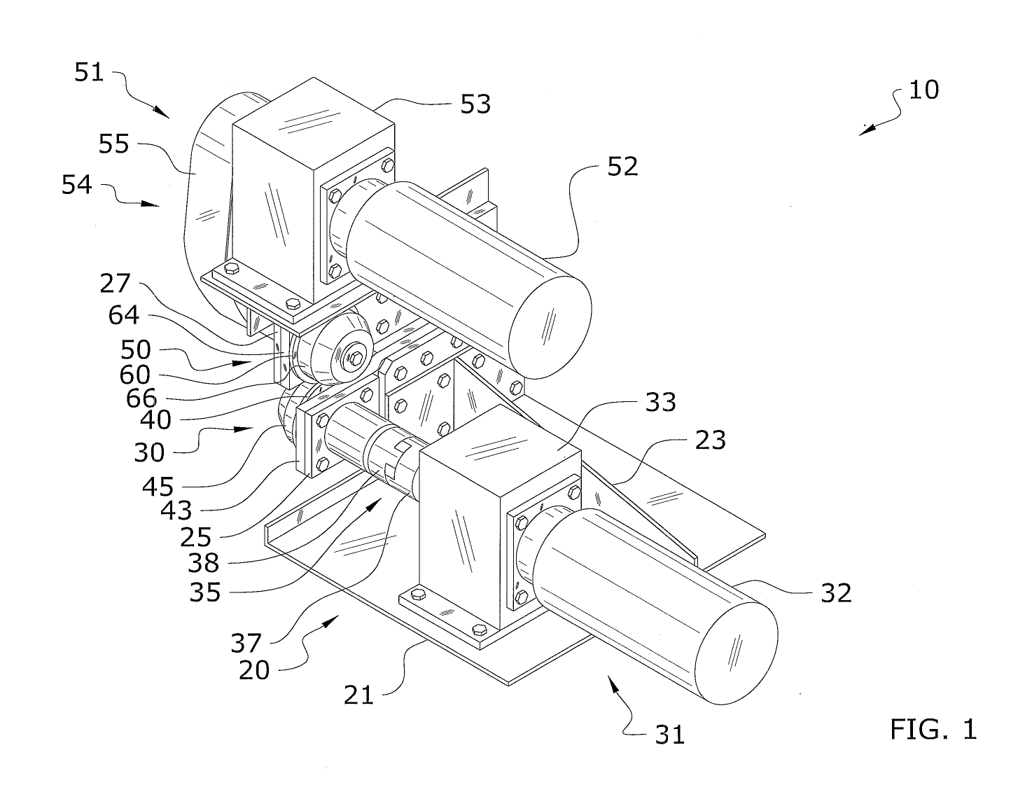

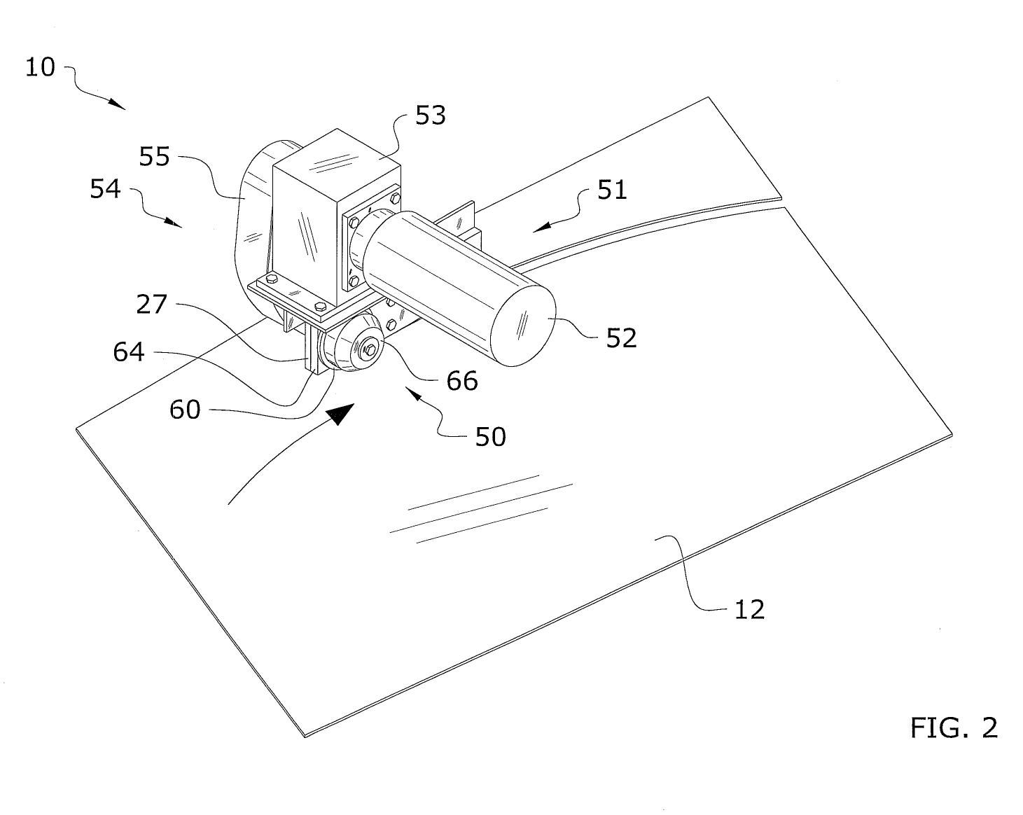

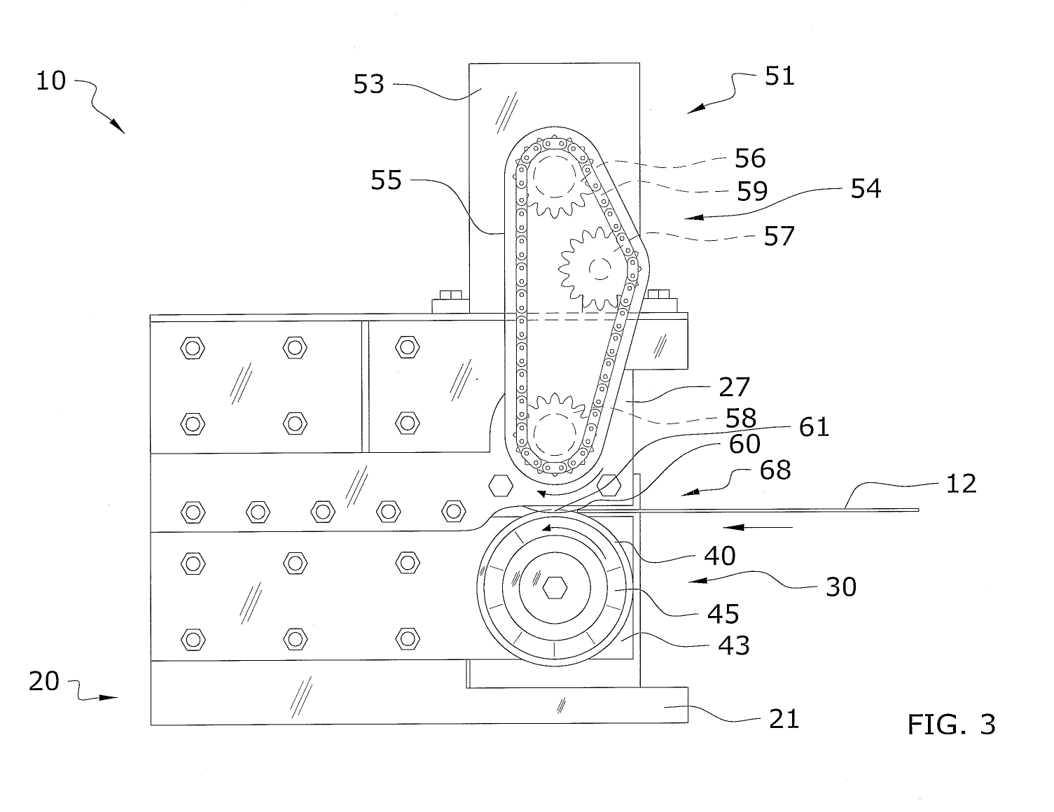

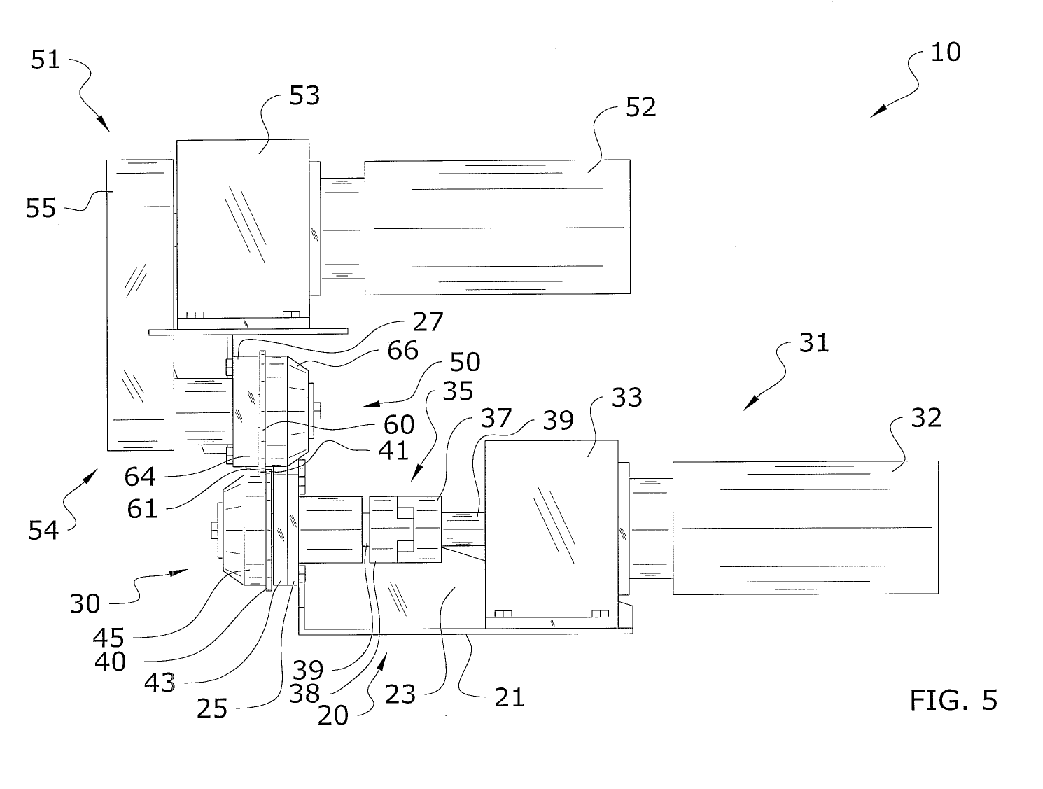

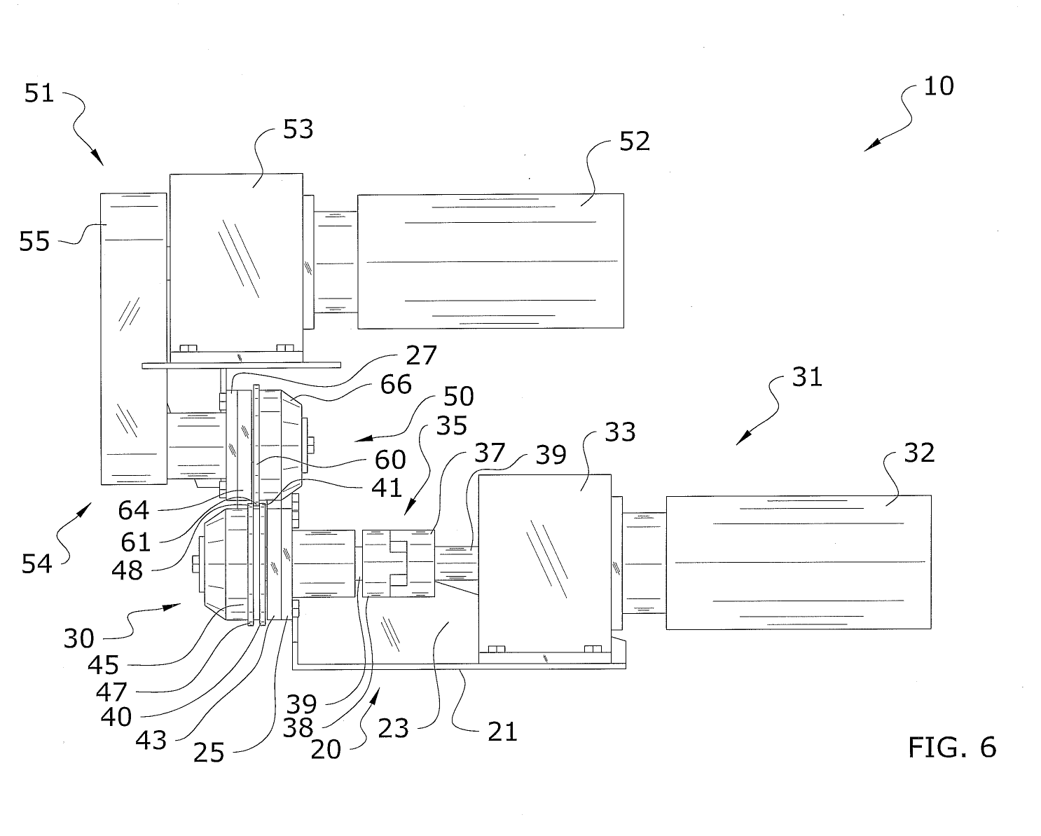

Turning now descriptively to the drawings, in which similar reference characters denote similar elements throughout the several views, FIGS. 1 through 6 illustrate a rotary sheet metal cutter 10, which comprises a base 20, a first cutting assembly 30 supported by the base 20 and including a first drive assembly 31 and a first circular blade 40, a second cutting assembly 50 supported by the base 20 and including a second drive assembly 51 and a second circular blade 60 cooperating with the first circular blade 40. The first circular blade 40 is driven in a first rotational direction and the second circular blade 60 is driven in a second rotational direction opposite the first rotational direction. The first circular blade 40 and the second circular blade 60 each include an overlapping portion 41, 61 along a feed path 68 for cutting a piece of sheet metal 12 engaging the overlapping portions 41, 61 of the first circular blade 40 and the second circular blade 60. Another circular blade 47 aligned with the first circular blade 40 may also be used.

### B. Base

The base 20 supports the cutting assemblies 30, 50. The base 20 is generally comprised of a heavy, rigid construction to provide support for the cutting assemblies 30, 50 while cutting heavy gauge sheet metal 12 (e.g. 10 gauge, etc.). The base 20 may be stationary and the sheet metal 12 moved with respect to the cutter 10 or the base 20 may be movable, such as including wheels, and the cutter 10 moved with respect to the sheet metal 12. The base 20 and cutting assemblies 30, 50 may be guided in various manners to form the desired curved cut through the sheet metal 12, such as free-handed, through the use of guide rods, handles extending from the base 20, or various other manners.

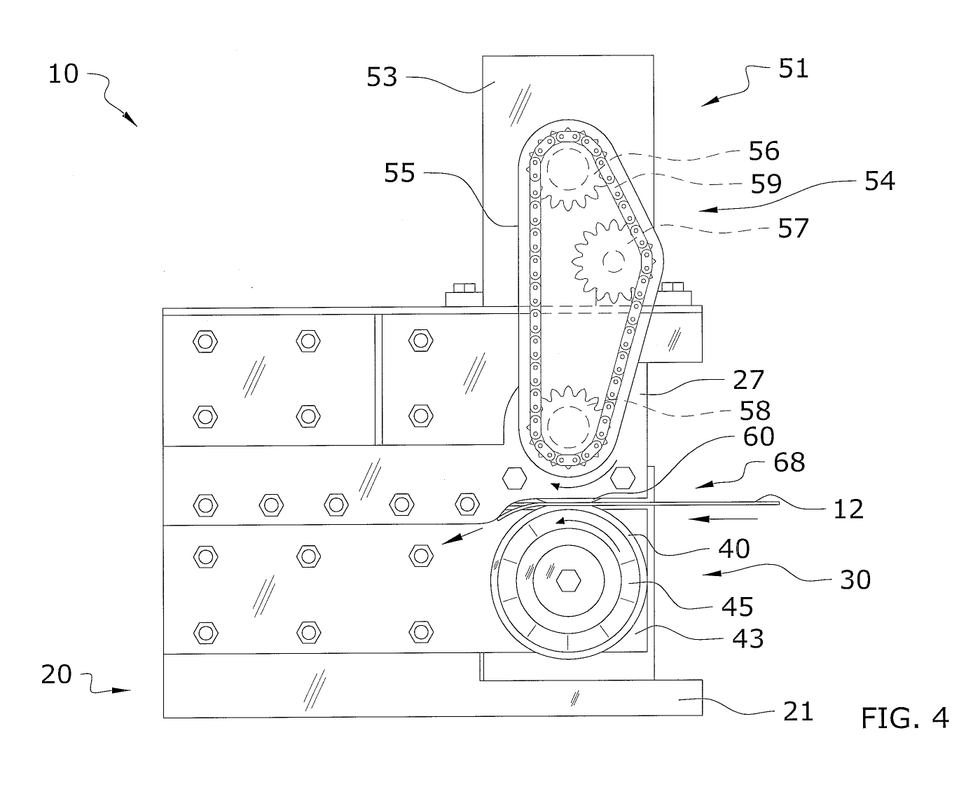

The base 20 generally includes a plate 21 forming a supporting bottom for the cutting assemblies 30, 50, a first support structure 25 extending vertically therefrom for primarily supporting the first cutting assembly 30, and a second support structure 27 extending vertically from the first support structure 25 for primarily supporting the second cutting assembly 50. Various supports 23 may also be used to secure the cutting assemblies 30, 50 to the base 20 preferably in a stacked manner, such that the cutting assemblies 30, 50 are vertically offset to assist in offsetting the blades 40, 60. As illustrated in FIG. 4, the second support structure 27 may also assist in separating the cut portions of the sheet metal 12 via a bulge extending downward from the second support structure 27.

### C. Cutting Assemblies

The cutting assemblies 30, 50 are generally supported by the base 20 in a stacked manner. The cutting assemblies 30, 50 generally each work to rotate one or more circular blades 40, 47, 60 to cut the sheet metal 12 in various manners, such as cutting curves, straight lines, diagonals, etc. In the preferred embodiment, the cutting assemblies 30, 50 cut curvatures for cone sections of a grain or storage bin.

The cutting assemblies 30, 50 each preferably include a motor 32, 52 for rotating a respective blade 40, 60. The motor 32, 52 may be electric, gas, or various other types. The motor 32, 52 is connected to a gearbox 33, 53 through a shaft, where a reduction of speed of the shaft generally takes place so that the circular blades 40, 60 rotate at a generally slow speed. Extending from the gear box 33, 53 is generally a transfer assembly 35, 54. It is appreciated that the transfer assembly 35, 54 may be comprised of various structures and may be omitted in embodiments where a direct connection to the circular blades 40, 60 can be achieved from the gear boxes 33, 53 via a single shaft.

In the illustrated embodiment, the first drive assembly 31 includes a first transfer assembly 35 generally including a pair of shafts 36, 39 each including couplers 37, 38 to be coupled together and transfer a rotational force outputted from the gear box 33 to the first lower blade 40 and second lower blade 47 (in the alternate embodiment).

In the illustrated embodiment, the second drive assembly 51 includes a second transfer assembly 54 generally including a plurality of sprockets 56-58 connected via an elongated chain 59 and enclosed via a casing 55 to transfer the rotational force outputted from the gear box 33, 53 to the blade 60. Various supports and other means of transferring rotational force may be used with either the first transfer assembly 35 or the second transfer assembly 54. For example, the second transfer assembly 54 may use pulleys and a belt to transfer the rotational force.

The first blade 40 of the first cutting assembly 30 is comprised of a circular blade including a body portion and a cutting edge. An upper portion of the cutting edge defines an overlapping portion 41 that overlaps the blade 60 of the second cutting assembly 50. An inner guard support 43 and outer guard support 45 may also be positioned upon opposing sides of the first blade 40 of the first cutting assembly 30 for supporting and guarding the blade 40. The cutting edge of the first blade 40 generally extends outwardly from the guard supports 43, 45, wherein the first blade 40 has a diameter greater than the guard supports 43, 45.

The first cutting assembly 30 may also include a second blade 47 to work in cooperation with the first blade 40. The second blade 47 is preferably concentric with the first blade 40 and rotates on the same axis of the first blade 40 that is driven by the first drive assembly 31. The second blade 47 is spaced slightly apart from the first blade 40 to allow room for the blade 60 of the second cutting assembly 50 therebetween. The second blade 47 also includes an overlapping portion 48 to overlap the blade 60 of the second cutting assembly 50 similarly to the first blade 40 of the first cutting assembly 30.

The blade 60 of the second cutting assembly 50 is comprised of a circular blade including a body portion and a cutting edge. An upper portion of the cutting edge defines an overlapping portion 61 that overlaps the first blade 40 of the first cutting assembly 30 and second blade 47 of the first cutting assembly 30 (in the alternate embodiment). An inner guard support 64 and outer guard support 66 may also be positioned upon opposing sides of the blade 60 of the second cutting assembly 50 for supporting and guarding the blade 60. The cutting edge of the blade 60 generally extends outwardly from the guard supports 64, 66, wherein the blade 60 has a diameter greater than the guard supports 64, 66.

All of the blades 40, 47, 60 generally rotate at the same speed, with the blades 40, 47 from the first cutting assembly 30 rotating in an opposite direction than the blade(s) 60 of the second cutting assembly 50. The blades 40, 47, 60 may also be sharpened or replaced as necessary. The blades 40, 47 of the first cutting assemblies 30, 50 are vertically offset from the blade 60 of the second cutting assembly 50. All of the blades 40, 47, 60 preferably include rotational axis that are positioned within parallel horizontal planes.

### D. Operation of Preferred Embodiment

In use, the sheet metal 12 is guided along the desired curved or straight cut into the feed path 68 of the cutter 10 which is defined as the overlapping portions 41, 48, 61 of the blades 40, 47, 60. The overlapping portions 41, 48, 61 of the circular blades 40, 47, 60 cooperatively work to shear the sheet metal 12 as the sheet metal 12 is pinched between the blades 40, 47 of the first cutting assembly 30 and the blades 60 of the second cutting assembly 50.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A rotary sheet metal cutter, comprising:
a base;
a first cutting assembly supported by said base;
wherein said first cutting assembly includes a first drive assembly and a first circular blade driven by said first drive assembly;
wherein said first circular blade is driven in a first rotational direction; and
a second cutting assembly supported by said base;
wherein said second cutting assembly includes a second drive assembly and a second circular blade driven by said second drive assembly and cooperating with said first circular blade;
wherein said second circular blade is driven in a second rotational direction opposite said first rotational direction;
wherein said first circular blade and said second circular blade each include a overlapping portion along a feed path for cutting a piece of sheet metal along said feed path engaging said overlapping portion of said first circular blade and said second circular blade.

2. The rotary sheet metal cutter of claim 1, wherein said first circular blade and said second circular blade rotate at equal speeds.

3. The rotary sheet metal cutter of claim 1, wherein a first axis of said first circular blade is parallel to a second axis of said second circular blade.

4. The rotary sheet metal cutter of claim 3, wherein said first axis and said second axis each are positioned within horizontal planes.

5. The rotary sheet metal cutter of claim 1, wherein said first circular blade and said second circular blade are vertically offset.

6. The rotary sheet metal cutter of claim 1, wherein said first drive assembly includes a first motor and a first gear box.

7. The rotary sheet metal cutter of claim 6, wherein said first drive assembly includes a transfer assembly to transfer a first rotational force from said first gear box to said first circular blade.

8. The rotary sheet metal cutter of claim 7, wherein said second drive assembly includes a second motor and a second gear box.

9. The rotary sheet metal cutter of claim 8, wherein said second drive assembly includes a transfer assembly to transfer a second rotational force from said second gear box to said second circular blade.

10. A rotary sheet metal cutter, comprising:
a base;
a first cutting assembly supported by said base;
wherein said first cutting assembly includes a first drive assembly;
wherein said first cutting assembly includes a first circular blade and a second circular blade both driven by said first drive assembly;
wherein said first circular blade and said second circular blade are driven in a first rotational direction; and
a second cutting assembly supported by said base;
wherein said second cutting assembly includes a second drive assembly and a third circular blade driven by said second drive assembly and cooperating with said first circular blade and said second circular blade;
wherein said third circular blade is driven in a second rotational direction opposite said first rotational direction;
wherein said first circular blade, said second circular blade, and said third circular blade each include a overlapping portion along a feed path for cutting a piece of sheet metal along said feed path engaging said overlapping portion of said first circular blade, said second circular blade, and said third circular blade.

11. The rotary sheet metal cutter of claim 10, wherein said overlapping portion of said third circular blade is positioned between said overlapping portion of said first circular blade and said second circular blade.

12. The rotary sheet metal cutter of claim 10, wherein said first circular blade, said second circular blade, and said third circular blade rotate at equal speeds.

13. The rotary sheet metal cutter of claim 10, wherein a first axis of said first circular blade and said second circular blade is parallel to a second axis of said third circular blade.

14. The rotary sheet metal cutter of claim 13, wherein said first axis and said second axis each are positioned within horizontal planes.

15. The rotary sheet metal cutter of claim 10, wherein said first circular blade is concentric with said second circular blade.

16. The rotary sheet metal cutter of claim 15, wherein said first circular blade are said second circular blade are vertically offset to said third circular blade.

17. The rotary sheet metal cutter of claim 10, wherein said first drive assembly includes a first motor and a first gear box.

18. The rotary sheet metal cutter of claim 17, wherein said second drive assembly includes a second motor and a second gear box.

19. The rotary sheet metal cutter of claim 10, wherein said first drive assembly is positioned substantially below said first drive assembly.

20. A rotary sheet metal cutter for cutting curves in sheet metal, comprising:
a base;
a first cutting assembly supported by said base;
wherein said first cutting assembly includes a first drive assembly and a first circular blade driven by said first drive assembly;
wherein said first drive assembly includes a first motor connected to a first gearbox, and wherein said first drive assembly includes a first transfer assembly interconnecting said first gearbox to said first circular blade;
wherein said first transfer assembly includes a pair of coupled shafts;
wherein said first cutting assembly includes a pair of first circular guard supports sandwiching said first circular blade;
wherein said first circular blade is driven in a first rotational direction; and
a second cutting assembly supported by said base, wherein said second cutting assembly is supported substantially above said first cutting assembly;
wherein said second cutting assembly includes a second drive assembly and a second circular blade driven by said second drive assembly and cooperating with said first circular blade;
wherein said second drive assembly includes a second motor connected to a second gearbox, and wherein said second drive assembly includes a second transfer assembly interconnecting said second gearbox to said second circular blade;
wherein said second transfer assembly includes a chain and sprocket assembly;
wherein said second cutting assembly includes a pair of second circular guard supports sandwiching said second circular blade;
wherein said second circular blade is driven in a second rotational direction opposite said first rotational direction;
wherein said first circular blade and said second circular blade each include a overlapping portion along a feed path for cutting a piece of sheet metal along said feed path engaging said overlapping portion of said first circular blade and said second circular blade;
wherein said first circular blade and said second circular blade rotate at equal speeds;
wherein a first axis of said first circular blade is parallel to a second axis of said second circular blade and wherein said first axis and said second axis each are positioned within horizontal planes.
